(19) United States
(12) Patent Application Publication
(10) Pub. No.: US 2016/0155126 A1
(43) Pub. Date: Jun. 2, 2016

(54) Method for Implementing and Integrating Biometric Markers, Identification, Real-Time Transaction Monitoring with Fraud Detection and Anti-Money Laundering Predictive Modeling Systems

(71) Applicant: Jack Nicholes D'Uva, McKinney, TX (US)

(72) Inventor: Jack Nicholes D'Uva, McKinney, TX (US)

(21) Appl. No.: 14/558,150

(22) Filed: Dec. 2, 2014

(51) Int. Cl. G06Q 20/40; G06Q 50/26

(52) U.S. Cl. CPC G06Q 20/4016; G06Q 50/265; G06Q 20/40145

(57) ABSTRACT

A method for implementing and integrating biometrical markers, identification, real-time transaction monitoring with fraud detection and anti-money laundering predictive modeling systems as the means of identifying, measuring, detecting and reporting the importance assigned to each member of a population of transactions coupled with images of participants whereby a relationship exists, or groups of relationships, by and between the transactions and the persons identified in the images and/or being affected by at least one suspicious activity factor, transaction or pattern. According to the method, an image is captured and attached to a financial transaction. An identifier is assigned to each member of the image population of persons making transactions for the benefit of one or more financial accounts. The image is cross-referenced against a cloud-based relational database of identified images, known associate persons per images and notations to purported activities and potential risk factors. The cloud-based relational database stores the shared information with subscribers cooperating in the uploading, updating and notating to the identifier record.

### BACKGROUND OF THE INVENTION

This invention is a method for implementing and integrating a robust, real-time, fraud detection/terror financing/anti-money laundering transaction monitoring and alerting that couples financial transactions with biometrical markers, such as images of the persons depositing, withdrawing, sending or receiving the transactions, attaching the captured image and financial transaction entry into a packet of information entered into the account records and stored on a secure server. Using facial-recognition/matching of images, captured, stored and updated in a cloud-based relational database shared by subscribers to the network. Each of one or more images are compared across the population of image records, real-time feeds, updates, and accompanying notes, to identify factors indicating suspicious activity such as fraud and/or terror financing and/or money laundering and the mandated requirement for reporting the suspected activity to law enforcement on the prescribed Suspicious Activity Report (SAR), Suspicious Transaction Report (STR), or other governmental reporting apparatus, with greater narrative detail while still maintaining the confidentiality of the reporting.

This invention is in the highly regulated field of international and domestic financial services with regulatory requirements statutorily imposed by governmental agencies upon banks, insurance companies, stock brokerages, money transfer, and other businesses to comply with certain automated transaction and reporting mandates under threat of penalty, fine or the loss of charter. More specifically, the invention comprises a method by which a financial institution, and its many branches and intermediaries may share information between each other on the patterns and identities of certain transaction participants in order to make better decisions regarding risk management and reporting requirements in safeguarding the financial institution from loss or regulatory action.

In the domestic and international financial industry there exist inherent heightened risks of crime syndicates, terrorist organizations, and other illicit businesses to use an institution, or several institutions, to facilitate money laundering operations using sophisticated methods of placement, layering and integration, and hide the cleansing of ill-gotten gain within the weaknesses of presently used rules-based, or behavior-based detection and alerting systems. This invention provides a more effective method of not only protecting the financial institution from internal or external losses but also assists in more fully satisfying the regulatory requirements of implementing and integrating robust compliance, detection and reporting systems in partnership with law enforcement agencies, financial regulators, and examiners.

For the first step, opening an account, which includes the onboarding of a customer and positive identification known as “CIP” (“CIP” is an acronym for “ Customer Information Profile”, idiom for the information gathering requirements of US federal law known as “BSA” (“BSA” is an acronym for Bank Secrecy Act”) and USA PATRIOT, also known as “The Patriot Act”), many financial institutions already screen their client databases against governmental watch-list databases known in the industry as “KYC databases” (“KYC” is an acronym for “Know Your Customer”, idiom for the general customer due diligence (“CDD”) policies mandated by government regulators and company procedures). The next scheduled review of the account after onboarding generally does not occur for another 12-18 months, unless there is some change in the beneficial ownership of the account, a negative news alerts the bank to potential challenges with the account of the account owner, or suspicious activity is noted to the account or the account owner, at which time the customer and the account are subject to heightened scrutiny, known as “EDD” (“EDD” is an acronym for “Enhanced Due Diligence”).

Waiting for a time determined review, a change in account status or the identification of potentially suspicious activity poses a problem for the institution(s), the industry and law enforcement in that by the time the review is started, the perpetrators of the illicit activity have already completed the operation, moving on to other venues and areas to continue the processing of their financial transactions. Thus, institutions and law enforcement are presently reacting only to past events rather than proactively monitoring ongoing activity and connecting the dots of related transactions, principal players, and minor participants inside and outside the institutions.

The following compliance steps relate to transaction monitoring for the purposes of risk management, regulatory compliance and reporting (comprising internal reports, external reports, compliance reports, and suspicious activity reports). Because there is no present standardized compliance model for transaction monitoring, institutions piece together systems that are ineffective, not efficient, non-collaborative, not intuitive and non-predictive thereby placing at risk the assets, reputation and charter of the institution.

Because of Industry wide recognition of the failings of present transaction monitoring methods, there is a consensus in favor of a risk-based, real-time transaction monitoring approach with positive identification of participants in the transactions across a wide platform of shared data by and between institutions, branches, and law enforcement. Such an approach requires some method of gathering the information, grouping records by risk factors, sharing the non-confidential elements of the transaction with subscribers, while safeguarding the confidential elements for reporting to law enforcement.

### SUMMARY OF THE INVENTION

This invention is a method for integrating biometrical markers, identification, real-time transaction monitoring with fraud detection and anti-money laundering predictive modeling systems as the means of identifying, measuring, detecting and reporting the importance assigned to each member of a population of transactions coupled with images of participants whereby a relationship exists, or groups of relationships, by and between the transactions and the persons identified in the images and/or being affected by at least one suspicious activity factor, transaction or pattern. According to the method, an image is captured and attached to a financial transaction. An identifier is assigned to each member of the image population of persons making transactions for the benefit of one or more financial accounts. The image is cross-referenced against a cloud-based relational database of identified images, known associate persons per images and notations to purported activities and potential risk factors. The cloud-based relational database stores the shared information with subscribers cooperating in the uploading, updating and notating to the identifier record.

Confidential information regarding the financial transactions, persons thereby associated to the transactions and the notations thereto are stored on the secure server at the institution. Confidential packets of information appertaining to the alleged perpetrators, the activities or transactions deemed suspicious for the potential filing of SARs or STRs are partitioned in the server and subsequent reports deemed necessary are filed via a secure connection to/from law enforcement, thereby safeguarding the confidential nature of the filings. Courses of action to be taken by the compliance department or risk management department related to the alleged perpetrators and the associated persons or accounts, are determined more effectively and with more precision and law enforcement are provided more detailed narratives and “connect-the-dots” information in real time.

### DESCRIPTION OF THE DRAWINGS

FIG. 1 is a graphical view of the method, the flow and processing of information, the relationships by and between subscribers sharing and accessing information, and the relationship by and between institutions and law enforcement.

FIG. 2 is a graphical view of the transaction details and the information sharing by and between institutions and law enforcement described in FIG. 1.

FIG. 3 is a graphical view of the flow of information by and between subscribers sharing and accessing information by way of the cloud-based relational database and the reporting to law enforcement of certain reports described in FIG. 1 and FIG. 2.

### REFERENCE NUMBERS IN THE DRAWINGS

| | | | |
|---|---|---|---|
| 100 camera | 105 image processor | 110 secure server | 120 identifier |
| | | | partition |
| 125 secure | 130 law enforcement | 135 internet access | 140 MSB customer |
| connection | | | |
| 200 image captured | 205 transaction | 210 coupled | 215 account record |
| and processed | details | transaction/image file | |
| 300 institution “a” | 310 institution “b” | 320 institution “c” | 330 institution “d” |
| 340 action alert | 350 human decision | 360 information | 400 report filed |
| | | packet | |

### DETAILED DESCRIPTION OF THE INVENTION

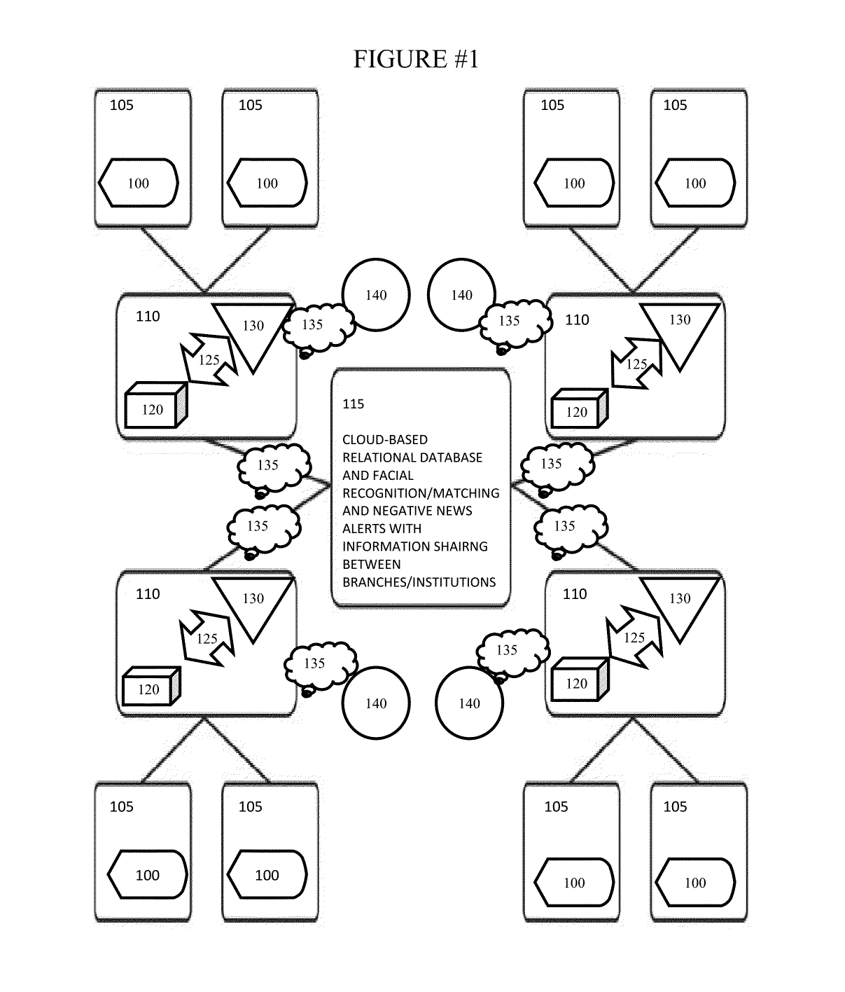

FIG. 1 shows a graphical perspective view of the present invention in a state of relation by and between the various parts and participants. Institution #1 and its branches use camera(s) 100, or other image capturing device, and captures the image at the time of the transaction, sends the image to the processor 105 to process the image and attach the image to the transaction record into a packet of information that is stored along with the account record on the secure server 110. Accessing the internet 135 an image and notations related to the transaction is cross-referenced across the platform of images and information, including, but not limited to, negative news, criminal watch lists, and other risk management related research, etc., on the subscription accessible cloud-based relational database 115. Facial-recognition/matching technology detects and marks the image with an identifier that stores similar images, associates and notations related to the image and the related records for future access and matching. Money service business 140 (known by the acronym “MSB”), a client of the institution with the same anti-money laundering compliance requirements, uploads images, account records and notations to the institution, for review by institution compliance personnel. Where and when suspicious activity is encountered with an account, account holder, or group of accounts, the details are entered or copied to the partition 120, reports are generated within the partition, maintaining the required confidentiality of the report, and sent via secure connection 125 to law enforcement 130. Institutions #2, #3, #4, etc., subscribe to the same cloud-based relational database and utilize the system in similar fashion, uploading images and notations, recognition/matching and updating record information for sharing across the subscribers.

Where and when this information sharing is of particular interest to the institutions and law enforcement exists in the areas of risk management, compliance, detection and transaction monitoring. Generally speaking, although banks require positive identification for persons withdrawing funds, no such requirement presently exists for persons depositing funds; so, presently, seemingly anonymous deposits are made to the accounts of other persons and businesses, as is the nature in financial transactions.

For example, supposing a nationwide drug trafficking operation, or other criminal organization, opens and maintains a business bank account ending in XXXX3444 for its legal-front business with Institution #1 at branch #232 in Denver, Colo. Presently, anonymous persons involved in organized criminal activity in multiple cities are able to deposit funds to the credit of XXXX3444 in branch #417 in Atlanta, Ga.; branch #391 in Pittsburgh, Pa.; and branch #119 in Los Angeles, Calif. of Institution #1 without detection, thereby perpetuating the laundering of ill-gotten gain while hiding their identities. Thus, branches in other cities are not generally concerned with the banking activities of the persons making deposits for customers holding accounts at other branches within the same institution, unless, of course, an alerting reason presents itself. The invention provides for information sharing by and between branches of Institution #1 with transaction details coupled with images of depositors, and other data that can be analyzed for risk management and law enforcement purposes alike. Personnel employed at differing branches become better informed and more cooperative when using the invention in cooperation across the platform. Additionally, information sharing exists between separate institutions or separate branches between separate institutions, as the perspective view of FIG. 1 demonstrates, so that criminal organizations utilizing more than one institution in the placement, layering or integration phases may be more effectively detected earlier in the scheme, thereby safeguarding the institution and also assisting law enforcement to more easily “connect the dots” of participants, players, and money routes.

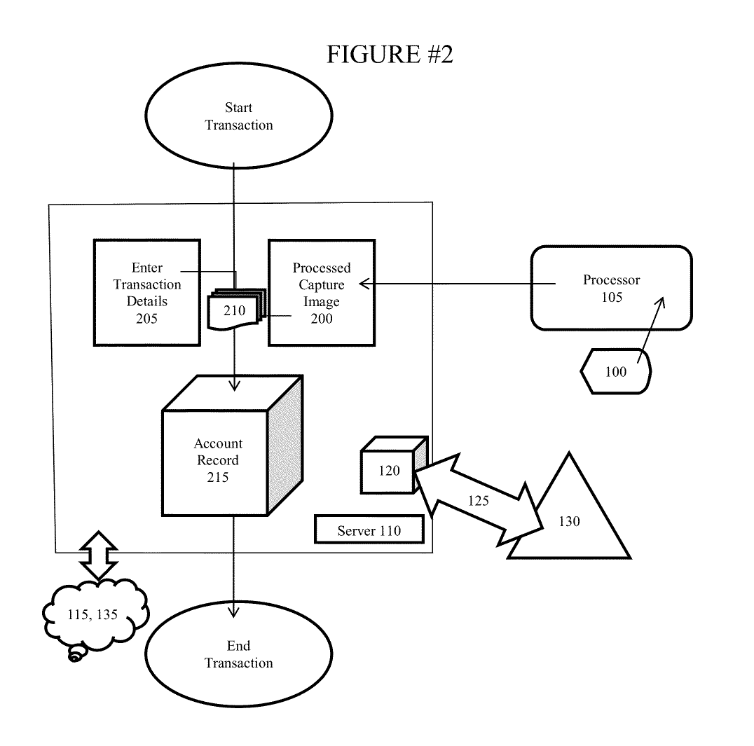

FIG. 2 provides a graphical perspective view of the flow of information contained in FIG. 1, with the Start Transaction, accessing the server 110, capturing the image with camera 100, processing image at processor 105 resulting in processed capture image 200 attached to enter transaction details 205 to become file 210 stored in account record 215. From the server 110 level, the cloud-based relational database 115 are accessed via internet 135 where information is uploaded, shared or downloaded to the account record 215. Also from the server 110 level, utilizing the data sharing features of the invention, a complete, confidential reporting record is created at secure partition 120 and communicated via secure connection 125 to law enforcement 130 for suspicious transactions, accounts, account holders, players or participants.

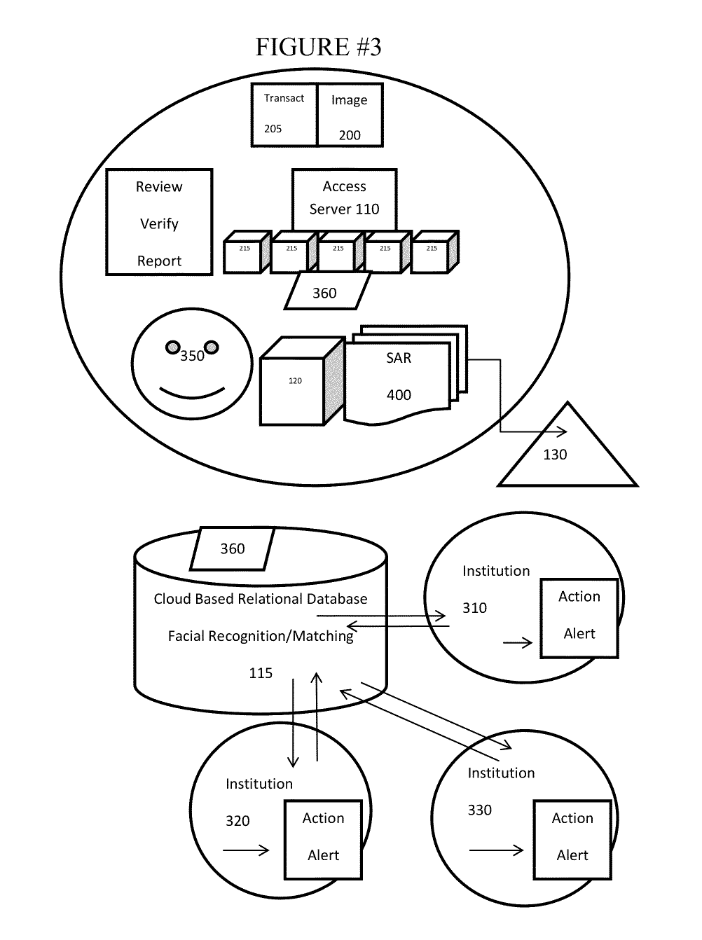

FIG. 3 provides an expanded perspective view of flow of information and data sharing features of the invention, contained in FIG. 1 and FIG. 2, where an institution 300 uses the accessed server 110 to store transition details 205 coupled with image 200 in an account record 215 for review, verification and reporting by compliance personnel 350 at some designated time or date. Accessing the cloud-based relational database 115, personnel 350 uses facial-recognition/matching features and notation entered into database in order to make decisions whether to post a transaction, or series of transactions, as “suspicious” on the secure partition 120 for the immediate submission, or submission at some later date, of a report SAR 400 (“suspicious activity report”) to law enforcement 130.

Additionally, bank compliance personnel 350 updates facial-recognition record data with entered notations and uploaded new images to the cloud-based relational database 115 for sharing with other institutional subscribers. Updated record 360 is copied to the account record 215 for future analysis or further action. Action alerts and updates are available to institutions 310, 320, 330, etc., to assist in record updating, transaction monitoring, compliance decision making, and reporting requirements.

Having described my invention, I claim:

1. A method for implementing and integrating a robust, real-time, fraud detection/terror financing/anti-money laundering transaction monitoring and alerting comprising: at least one camera or other image capturing device coupled to at least one processor having stored thereon instructions which, when executed by the at least one processor, causes the at least one processor to perform operations comprising:
capture at least one image, in a digital format, of a personage conducting a financial transaction at the time of the transaction; and at least one computing and memory device or other shared server computing device, having stored thereon instructions which, when executed, causes the at least one image to be coupled and stored with the corresponding entered financial transaction into an account record stored on the at least one computing and memory device or other shared server computing device upon which financial transaction information is usually stored and accessed; and at least one primary point of access to and from the internet and the shared server computing device; and at least one secure partition located on the shared server computing device; and at least one secure connection to and from the law enforcement ensuring the confidentiality of reports communicated to and from law enforcement; and the one cloud-based relational database accessible by subscription to many subscribers via internet connection comprising: a biometrical recognition and matching system comprising: a searchable database against which the at least one image is compared against other stored images and information in the searchable database; and the capability of updating, uploading and downloading of images and information; and thereupon outputting a result, or series of results, based on the determination of whether the image of the personage matches other images of the same personage, and/or otherwise matches known associates of the personage, from the images and information stored, accessed, and updated in the one cloud-based relational database; and at least one subscriber to the one cloud-based relational database.

2. A method for implementing and integrating a robust, real-time, fraud detection/terror financing/anti-money laundering transaction monitoring and alerting as recited in claim 1, wherein said camera or other image capturing device further comprising multiple cameras, or other image capturing devices are coupled with the said at least one processor further comprising multiple processors.

3. A method for implementing and integrating a robust, real-time, fraud detection/terror financing/anti-money laundering transaction monitoring and alerting as recited in claim 1, wherein the said one cloud-based relational database further comprising multiple access points via internet connection.

4. A method for implementing and integrating a robust, real-time, fraud detection/terror financing/anti-money laundering transaction monitoring and alerting as recited in claim 3, wherein the said one cloud-based relational database further comprising multiple cloud-based relational databases.

5. A method for implementing and integrating a robust, real-time, fraud detection/terror financing/anti-money laundering transaction monitoring and alerting as recited in claim 1, wherein the said at least one secure partition located on the shared server computing device further comprises multiple secure partitions located on the shared server computing device.

6. A method for implementing and integrating a robust, real-time, fraud detection/terror financing/anti-money laundering transaction monitoring and alerting as recited in claim 5, wherein the said at least one secure partition located on the shared server computing device further comprises multiple secure partitions outside a shared server computing device.

7. A method for implementing and integrating a robust, real-time, fraud detection/terror financing/anti-money laundering transaction monitoring and alerting as recited in claim 1, wherein the said at least one secure connection to and from the law enforcement ensuring the confidentiality of reports communicated to and from law enforcement further comprised multiple secure connections to and from law enforcement.

8. A method for implementing and integrating a robust, real-time, fraud detection/terror financing/anti-money laundering transaction monitoring and alerting as recited in claim 1, wherein the said at least one subscriber to the said at least one cloud-based relational database further comprises multiple subscribers.
